(19) United States
(12) Patent Application Publication
(10) Pub. No.: US 2012/0129965 A1
(43) Pub. Date: May 24, 2012

(54) USE OF FILM-FORMING POLYMERS AND ORGANIC HOLLOW PARTICLES FOR COATING AGENTS

(75) Inventors: Arno Tuchbreiter, Charlotte, NC (US); Oliver Wagner, Osthofen (DE); Chris Titmarsh, Mannheim (DE)

(73) Assignee: BASF SE, Ludwigshafen (DE)

(21) Appl. No.: 13/384,831

(22) PCT Filed: Jul. 21, 2010
(86) PCT No.: PCT/EP10/60512

§ 371 Date: Feb. 9, 2012

(30) Foreign Application Priority Data
Jul. 22, 2009 (EP) 09166115.7

(51) Int. Cl. C09D 133/12; B82Y 30/00

(52) U.S. Cl. 521/139; 977/773

(57) ABSTRACT

The present invention relates to the use of a mixture of film-forming polymers and hollow organic particles for coating materials, especially in paints, and to coating materials comprising such blends.

The present invention relates to the use of a mixture of film-forming polymers and hollow organic particles for coating materials, more particularly in paints, and also to coating materials comprising such blends.

Hollow organic particles are a particular variety of core/shell particles composed in dried form of an air-filled cavity surrounded by a hard shell. This construction gives them the particular property of scattering light, which is the reason for their use as a white pigment in paints, paper coatings, and cosmetics, suncreams for example. In such systems they replace part of the inorganic white pigment titanium dioxide, and also boost the effect of the remaining TiO₂.

C. J. McDonald and M. J. Devon, in Advances in Colloid and Interface Science 2002, 99, 181-213, describe a range of possibilities for producing these hollow particles, including swelling with organic solvents or blowing agents, encapsulation of hydrocarbons, or approaches building on W/O/W emulsions. The method that is preferred, however, on both environmental and economic grounds, is the osmotic swelling of specific core/shell particles.

EP 1 904 544 discloses the preparation of hollow organic particles.

Film-forming polymers are known from the prior art and are disclosed for example in EP 939 774.

WO 94/04603 discloses the use of hollow organic particles in combination with a binder, the preparation of the hollow particles with an acid-free core, and the final dispersion, taking place in both an environmentally and an economically less preferential method at a significantly higher temperature. The resulting hollow particles have an average diameter of 800 nm or more. Hollow particles of this kind are used preferably for paper coatings, where a primary roll is played not only by the opacity of the coating but also by its gloss after calendering.

JP60223873 likewise discloses mixtures of a water-based coating composition with microcavities, produced by blending a film-forming polymer dispersion with a non-film-forming polymer dispersion, composed of a multilayer particle. The process of producing the polymer particles with microcavity is fundamentally different from the operation disclosed in this invention.

The compositions of the prior art first have the disadvantage that they are less favorable from the standpoints both of economics and of the environment, and, second, they do not meet the desired requirements in terms of hiding power and wet abrasion resistance: It was an object of the present invention, therefore, to develop a water-based dispersion as a coating material for increasing the spreading rate and the wet abrasion resistance of exterior and interior paints by blending of hollow organic particles, obtainable by a process that avoids the disadvantages of the prior-art processes, with at least one aqueous dispersion of a film-forming polymer (PD).

This object has been achieved in accordance with the invention through the use of a blend of an aqueous dispersion of hollow organic particles with at least one aqueous dispersion of a film-forming polymer (PD), wherein the hollow organic particles are obtained by a process for preparing emulsion polymer particles by preparing a

multistage emulsion polymer by sequential polymerization of
i) a seed, subsequent reaction with
ii) a swell seed comprising 0 to 100% by weight of at least one nonionically ethylenically unsaturated monomer and 0 to 40% by weight of at least one monoethylenically unsaturated hydrophilic monomer, based in each case on the total weight of the core stage polymer comprising both seed and swell seed, subsequent polymerization with
iii) a first shell comprising 85% to 99.9% by weight of at least one nonionically ethylenically unsaturated monomer and 0.1% to 15% by weight of at least one hydrophilic monoethylenically unsaturated monomer, subsequent polymerization of
iv) a second shell comprising 85% to 99.9% by weight of at least one nonionically ethylenically unsaturated monomer and 0.1% to 15% by weight of at least one hydrophilic monoethylenically unsaturated monomer, subsequent addition of
v) at least one plasticizer monomer having a ceiling temperature of less than 181° C., preferably less than 95° C.
vi) neutralization to a pH of at least 7.5 or more, preferably more than 8, of the resultant particles with a base, subsequent polymerization of
vii) a third shell comprising 90% to 99.9% by weight of at least one nonionically ethylenically unsaturated monomer and 0.1% to 10% by weight of at least one hydrophilic monoethylenically unsaturated monomer
viii) and, optionally, polymerization of further shells comprising at least one nonionically ethylenically unsaturated monomer and at least one hydrophilic monoethylenically unsaturated monomer
as coating composition.

The invention further provides coating materials in the form of an aqueous composition comprising:

a blend of at least one aqueous dispersion of hollow organic particles, as defined below, and of at least one aqueous dispersion of a film-forming polymer (PD), as defined below,

if desired, at least one inorganic filler and/or inorganic pigment,

typical auxiliaries, and

water to 100% by weight.

The invention further provides for the use of a blend of an aqueous dispersion of inventive hollow organic particles with at least one aqueous dispersion of a film-forming polymer (PD) as an additive for an aqueous coating material for increasing the hiding power and/or the wet abrasion resistance.

The invention additionally provides for the use of a blend of an inventive aqueous dispersion of hollow organic particles with an aqueous dispersion of a film-forming polymer (PD) as an additive for paints.

The invention additionally provides for the use of a blend of an inventive aqueous dispersion of hollow organic particles with an aqueous dispersion of a film-forming polymer (PD) as an additive for interior and exterior paints.

The blend ratio of the aqueous dispersion comprising the film-forming polymer with the aqueous dispersion comprising the hollow organic particle is 30:70, preferably 20:80 or 5:95, with particular preference 10:90.

One advantage of the invention is that in the preparation of the hollow organic particles in stage (iv), when using monomers whose ceiling temperature (Frieder Vieweg & Sohn Verlagsgesellschaft mbH, Braunschweig/Wiesbaden, 1997) is below the swelling temperature or—as an extreme case thereof—monomers which for thermodynamic reasons are unable to form a homopolymer, the disadvantages of the prior art can be gotten around and swelling is possible without addition of polymerization inhibitors or reducing agents, even in the presence of residual amounts of initiator, and—what is more—the preferred swelling temperature is below 100° C.

In the context of the present invention, the expression “alkyl” encompasses straight-chain and branched alkyl groups. Examples of suitable short-chain alkyl groups are straight-chain or branched C₁-C₇ alkyl, preferably C₁-C₆ alkyl, and more preferably C₁-C₄ alkyl groups. These include more particularly methyl, ethyl, propyl, isopropyl, n-butyl, 2-butyl, sec-butyl, tert-butyl, n-pentyl, 2-pentyl, 2-methylbutyl, 3-methylbutyl, 1,2-dimethylpropyl, 1,1-dimethylpropyl, 2,2-dimethylpropyl, 1-ethylpropyl, n-hexyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 2-ethylpentyl, 1-propylbutyl, etc.

Suitable longer-chain C₈-C₃₀ alkyl groups are straight-chain and branched alkyl groups. Preferably they are predominantly linear alkyl radicals, such as also occur in natural or synthetic fatty acids and fatty alcohols and also in oxo-process alcohols. They include, for example, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, etc. The expression “alkyl” encompasses unsubstituted and substituted alkyl radicals.

The above observations concerning alkyl also apply to the alkyl moities in arylalkyl. Preferred arylalkyl radicals are benzyl and phenylethyl.

C₈-C₃₂ Alkenyl in the context of the present invention stands for straight-chain and branched alkenyl groups, which may be singly, doubly or multiply unsaturated. Preference is given to C₁₀-C₂₀ alkenyl. The expression “alkenyl” encompasses unsubstituted and substituted alkenyl radicals. Especially they are predominantly linear alkenyl radicals, such as also occur in natural or synthetic fatty acids and fatty alcohols and also in oxo-process alcohols. They include more particularly octenyl, nonenyl, decenyl, undecenyl, dodecenyl, tridecenyl, tetradecenyl, pentadecenyl, hexadecenyl, heptadecenyl, octadecenyl, nonadecenyl, linolyl, linolenyl, eleostearyl, and oleyl (9-octadecenyl).

The expression “alkylene” for the purposes of the present invention stands for straight-chain or branched alkanediyl groups having 1 to 7 carbon atoms, e.g., methylene, 1,2-ethylene, 1,3-propylene, etc.

Cycloalkyl is preferably C₄-C₈ cycloalkyl, such as cyclobutyl, cyclopentyl, cyclohexyl, cyclo-heptyl or cyclooctyl.

The expression “aryl” in the context of the present invention encompasses monocyclic or polycyclic aromatic hydrocarbon radicals which may be unsubstituted or substituted. The expression “aryl” stands preferably for phenyl, tolyl, xylyl, mesityl, duryl, naphthyl, fluorenyl, anthracenyl, phenanthrenyl or naphthyl, more preferably for phenyl or naphthyl, it being possible for these aryl groups, in the case of substitution, to carry generally 1, 2, 3, 4 or 5, preferably 1, 2 or 3, substituents.

The process of the invention for preparing the hollow organic particles constitutes a multistage sequential emulsion polymerization. “Sequential” relates to the implementation of the individual stages, it also being possible for each individual stage to be composed of a plurality of sequential steps.

The term “seed” relates to an aqueous polymer dispersion which is used at the beginning of the multistage polymerization and is the product of an emulsion polymerization, or may relate to an aqueous polymer dispersion present at the end of one of the polymerization stages for preparing the hollow particle dispersion, with the exception of the last stage.

The seed which is used at the beginning of the polymerization of the first stage can also be prepared in situ and is composed preferably of acrylic acid, methacrylic acid, esters of acrylic acid and methacrylic acid, or mixtures thereof. Particularly preferred mixtures are those of n-butyl acrylate, methyl methacrylate, and methacrylic acid.

The average particle size of the seed polymer in the unswollen state is 40 to 100 nm, preferably 60 to 90 nm.

The swell seed comprises 0 to 100% by weight, preferably 55% to 80% by weight, of a nonionically ethylenically unsaturated monomer and 0 to 45% by weight, preferably 20% to 35% by weight, of a monoethylenically unsaturated hydrophilic monomer.

The weight ratio of the swell seed (ii) to the seed polymer (i) is 2:1 to 50:1, preferably 2:1 to 30:1. The average particle size, in the unswollen state, of the core stage polymer composed of seed (i) and swell seed (ii) is 100 to 400 nm, preferably 100 to 250 nm.

The glass transition temperature, determined by the Fox equation (John Wiley & Sons Ltd., Baffins Lane, Chichester, England, 1997), of the core stage polymer is between −20° C. and 150° C.

The nonionically ethylenically unsaturated monomers comprehend styrene, vinyltoluene, ethylene, butadiene, vinyl acetate, vinyl chloride, vinylidene chloride, acrylonitrile, acrylamide, methacrylamide, (C₁-C₂₀)alkyl or (C₃-C₂₀)alkenyl esters of acrylic or methacrylic acid, methacrylate, methyl methacrylate, ethyl acrylate, ethyl methacrylate, butyl acrylate, butyl methacrylate, 2-ethylhexyl acrylate, 2-ethylhexyl methacrylate, benzyl acrylate, benzyl methacrylate, lauryl acrylate, lauryl methacrylate, oleyl acrylate, oleyl methacrylate, palmityl acrylate, palmityl methacrylate, stearyl acrylate, stearyl methacrylate, hydroxyl-containing monomers, more particularly C₁-C₁₀ hydroxyalkyl (meth)acrylates, such as hydroxyethyl (meth)acrylate, hydroxypropyl (meth)acrylate, glycidyl (meth)acrylate, ricinoleic acid, palmitoleic acid, oleic acid, elaidic acid, vaccenic acid, icosenoic acid, cetoleic acid, erucic acid, nervonic acid, linoleic acid, linolenic acid, arachidonic acid, timnodonic acid, clupanodonic acid.

The monoethylenically unsaturated hydrophilic monomers comprehend acrylic acid, methacrylic acid, acryloyloxypropionic acid, methacryloyloxypropionic acid, acryloyloxyacetic acid, methacryloyloxyacetic acid, crotonic acid, aconitic acid, itaconic acid, monomethyl maleate, maleic acid, monomethyl itaconate, maleic anhydride, fumaric acid, monomethyl fumarate, itaconic anhydride, and itaconic acid monomethyl ester.

The first shell (iii) comprises 85% to 99.9% by weight of at least one nonionically ethylenically unsaturated monomer, preferably 90% to 99.9% by weight, and 0.1% to 15% by weight, preferably 0.1% to 10% by weight, of at least one hydrophilic monoethylenically unsaturated monomer.

The nonionically ethylenically unsaturated monomers comprehend styrene, vinyltoluene, ethylene, butadiene, vinyl acetate, vinyl chloride, vinylidene chloride, acrylonitrile, acrylamide, methacrylamide, (C₁-C₂₀)alkyl or (C₃-C₂₀)alkenyl esters of acrylic or methacrylic acid, methacrylate, methyl methacrylate, ethyl acrylate, ethyl methacrylate, butyl acrylate, butyl methacrylate, 2-ethylhexyl acrylate, 2-ethylhexyl methacrylate, benzyl acrylate, benzyl methacrylate, lauryl acrylate, lauryl methacrylate, oleyl acrylate, oleyl methacrylate, palmityl acrylate, palmityl methacrylate, stearyl acrylate, stearyl methacrylate, hydroxyl-containing monomers, more particularly C₁-C₁₀ hydroxyalkyl (meth)acrylates, such as hydroxyethyl (meth)acrylate, hydroxypropyl (meth)acrylate, glycidyl (meth)acrylate, ricinoleic acid, palmitoleic acid, oleic acid, elaidic acid, vaccenic acid, icosenoic acid, cetoleic acid, erucic acid, nervonic acid, linoleic acid, linolenic acid, arachidonic acid, timnodonic acid, clupanodonic acid, preferably styrene, acrylonitrile, methacrylamide, methacrylate, methyl methacrylate, ethyl acrylate, ethyl methacrylate, butyl acrylate, butyl methacrylate, 2-ethylhexyl acrylate, and 2-ethylhexyl methacrylate.

The monoethylenically unsaturated hydrophilic monomers comprehend acrylic acid, methacrylic acid, acryloyloxypropionic acid, methacryloyloxypropionic acid, acryloyloxyacetic acid, methacryloyloxyacetic acid, crotonic acid, aconitic acid, itaconic acid, monomethyl maleate, maleic acid, monomethyl itaconate, maleic anhydride, fumaric acid, monomethyl fumarate, preferably acrylic acid, methacrylic acid, itaconic acid, itaconic anhydride, and itaconic acid monomethyl ester.

This first shell (iii) encloses the core stage polymer. The weight ratio of the core stage polymer to the first shell (iii) is 20:1 to 1:1, preferably 10:1 to 1:1, and the shell polymer possesses a glass transition temperature according to the Fox equation of between −60° C. to 120° C.

The particle size of this stage in the unswollen state is 120 nm to 500 nm, preferably 150 to 270 nm.

The second shell (iv) comprises 85% to 99.9%, preferably 90% to 99.9% by weight, of at least one nonionically ethylenically unsaturated monomer, and 0.1% to 15% by weight, preferably 0.1% to 10% by weight, of at least one hydrophilic monoethylenically unsaturated monomer.

The nonionically ethylenically unsaturated monomers comprehend styrene, vinyltoluene, ethylene, butadiene, vinyl acetate, vinyl chloride, vinylidene chloride, acrylonitrile, acrylamide, methacrylamide, (C₁-C₂₀)alkyl or (C₃-C₂₀)alkenyl esters of acrylic or methacrylic acid, methacrylate, methyl methacrylate, ethyl acrylate, ethyl methacrylate, butyl acrylate, butyl methacrylate, 2-ethylhexyl acrylate, 2-ethylhexyl methacrylate, benzyl acrylate, benzyl methylacrylate, lauryl acrylate, lauryl methacrylate, oleyl acrylate, oleyl methacrylate, palmityl acrylate, palmityl methacrylate, stearyl acrylate, stearyl methacrylate, hydroxyl-containing monomers, more particularly C₁-C₁₀ hydroxyalkyl (meth)acrylates, such as hydroxyethyl (meth)acrylate, hydroxypropyl (meth)acrylate, glycidyl (meth)acrylate, ricinoleic acid, palmitoleic acid, oleic acid, elaidic acid, vaccenic acid, icosenoic acid, cetoleic acid, erucic acid, nervonic acid, linoleic acid, linolenic acid, arachidonic acid, timnodonic acid, clupanodonic acid, preferably styrene, acrylonitrile, methacrylamide, methyl acrylate, methyl methacrylate, ethyl acrylate, ethyl methacrylate, butyl acrylate, butyl methacrylate, 2-ethylhexyl acrylate, and 2-ethylhexyl methacrylate.

The monoethylenically unsaturated hydrophilic monomers comprehend acrylic acid, methacrylic acid, acryloyloxypropionic acid, methacryloyloxypropionic acid, acryloyloxyacetic acid, methacryloyloxyacetic acid, crotonic acid, aconitic acid, itaconic acid, monomethyl maleate, maleic acid, monomethyl itaconate, maleic anhydride, fumaric acid, monomethyl fumarate, preferably acrylic acid, methacrylic acid, itaconic acid, itaconic anhydride, and itaconic acid monomethyl ester.

The first shell is ensheathed by the second shell and the weight ratio of the first shell (iii) to the second shell (iv) is 1:30 to 1:1, preferably 1:20 to 1:1, and the shell polymer possesses a glass transition temperature according to Fox of 50 to 120° C. The average particle size of this stage is 200 to 1500 nm, preferably 250 to 600 nm.

The plasticizer monomer listed under (v) comprehends, for example, α-methylstyrene, esters of 2-phenylacrylic acid/atropic acid (e.g., methyl, ethyl, n-propyl, n-butyl), 2-methyl-2-butene, 2,3-dimethyl-2-butene, 1,1-diphenylethene or methyl 2-tert-butylacrylate, and also other monomers listed in J. Brandrup, E. H. lmmergut, Polymer Handbook 3rd Edition, II/316 ff. A preferred plasticizer monomer used is α-methylstyrene.

The neutralization listed under (vi) takes place with a base for swelling the core and hence forming the hollow particle. Examples of bases which can be used include alkali metal or alkaline earth metal compounds such as sodium hydroxide, potassium hydroxide, calcium hydroxide, magnesium oxide, sodium carbonate; ammonia; primary, secondary, and tertiary amines, such as ethylamine, propylamine, monoisopropylamine, monobutylamine, hexylamine, ethanolamine, dimethylamine, diethylamine, di-n-propylamine, tributylamine, triethanolamine, dimethoxyethylamine, 2-ethoxyethylamine, 3-ethoxypropylamine, dimethylethanolamine, diisopropanolamine, morpholine, ethylenediamine, 2-diethylaminethylamine, 2,3-diaminopropane, 1,2-propylenediamine, dimethylaminopropylamine, neopentanediamine, hexamethylenediamine, 4,9-dioxadodecane-1,12-diamine, polyethyleneimine or polyvinylamine.

The third shell (vii) comprises 90% to 99.9%, preferably 95% to 99.9% by weight of at least one nonionically ethylenically unsaturated monomer, and 0.1% to 10%, preferably 0.1% to 5% by weight of at least one hydrophilic monoethylenically unsaturated monomer.

The nonionically ethylenically unsaturated monomers comprehend styrene, vinyltoluene, ethylene, butadiene, vinyl acetate, vinyl chloride, vinylidene chloride, acrylonitrile, acrylamide, methacrylamide, (C₁-C₂₀ )alkyl or (C₃-C₂₀)alkenyl esters of acrylic or methacrylic acid, methacrylate, methyl methacrylate, ethyl acrylate, ethyl methacrylate, butyl acrylate, butyl methacrylate, 2-ethylhexyl acrylate, 2-ethylhexyl methacrylate, benzyl acrylate, benzyl methylacrylate, lauryl acrylate, lauryl methacrylate, oleyl acrylate, oleyl methacrylate, palmityl acrylate, palmityl methacrylate, stearyl acrylate, stearyl methacrylate, hydroxyl-containing monomers, more particularly C₁-C₁₀ hydroxyalkyl (meth)acrylates, such as hydroxyethyl (meth)acrylate, hydroxypropyl (meth)acrylate, glycidyl (meth)acrylate, ricinoleic acid, palmitoleic acid, oleic acid, elaidic acid, vaccenic acid, icosenoic acid, cetoleic acid, erucic acid, nervonic acid, linoleic acid, linolenic acid, arachidonic acid, timnodonic acid, clupanodonic acid, preferably styrene, acrylonitrile, methacrylamide, methacrylate, methyl methacrylate, ethyl acrylate, ethyl methacrylate, butyl acrylate, butyl methacrylate, 2-ethylhexyl acrylate, and 2-ethylhexyl methacrylate.

The monoethylenically unsaturated hydrophilic monomers comprehend acrylic acid, methacrylic acid, acryloyloxypropionic acid, methacryloyloxypropionic acid, acryloyloxyacetic acid, methacryloyloxyacetic acid, crotonic acid, aconitic acid, itaconic acid, monomethyl maleate, maleic acid, monomethyl itaconate, maleic anhydride, fumaric acid, monomethyl fumarate, preferably acrylic acid, methacrylic acid, itaconic acid, itaconic anhydride, and itaconic acid monomethyl ester.

The third shell as well envelops the second shell and the weight ratio of the third shell to the second shell is 5:1 to 1:2, preferably 3:1 to 1:1, and the shell polymer possesses a glass transition temperature according to Fox of 50 to 120° C.

The average final particle size is be 300 to 800 nm.

In painting, the pigments employed, especially TiO_{2,} may be replaced completely or partly by the polymer dispersion described here. Typically such paints comprise, among other constituents, water, thickener, aqueous sodium hydroxide solution, pigment dispersant, associative thickener, defoamer, biocide, binder, and film-forming assistant.

The polymers can be prepared by typical polymerization processes of emulsion polymerization. It is preferred to operate in the absence of oxygen, preferably in a stream of nitrogen. For the polymerization method the typical apparatus is used, examples being stirred tanks, stirred tank cascades, autoclaves, tube reactors, and kneading apparatus. The polymerization can be performed in solvents or diluents, such as toluene, o-xylene, p-xylene, cumene, chlorobenzene, ethylbenzene, technical mixtures of alkylaromatics, cyclohexane, technical aliphatics mixtures, acetone, cyclohexanone, tetrahydrofuran, dioxane, glycols and glycol derivatives, polyalkylene glycols and their derivatives, diethyl ether, tert-butyl methyl ether, methyl acetate, isopropanol, ethanol, water or mixtures such as isopropanol/water mixtures, for example.

The polymerization can be conducted at temperatures from 20 to 300° C., preferably from 50 to 200° C.

The polymerization is preferably conducted in the presence of compounds which form free radicals. These compounds are required in amounts of up to 30%, preferably 0.05% to 15%, more preferably 0.2% to 8% by weight, based on the monomers used in the polymerization. In the case of multicomponent initiator systems (redox initiator systems, for example) the above weight figures are based on the sum total of the components.

Examples of suitable polymerization initiators include peroxides, hydroperoxides, peroxydisulfates, percarbonates, peroxy esters, hydrogen peroxide, and azo compounds. Examples of initiators, which may be water-soluble or else water-insoluble, are hydrogen peroxide, dibenzoyl peroxide, dicyclohexyl peroxydicarbonate, dilauroyl peroxide, methyl ethyl ketone peroxide, di-tert-butyl peroxide, acetylacetone peroxide, tert-butyl hydroperoxide, cumene hydroperoxide, tert-butyl perneodecanoate, tert-amyl perpivalate, tert-butyl perpivalate, tert-butyl perneohexanoate, tert-butyl per-2-ethylhexanoate, tert-butyl perbenzoate, lithium, sodium, potassium and ammonium peroxydisulfate, azodiisobutyronitrile, 2,2′-azobis(2-amidinopropane) dihydrochloride, 2-(carbamoylazo)isobutyronitrile, and 4,4-azobis(4-cyanovaleric acid).

The initiators can be employed alone or in a mixture with one another, examples being mixtures of hydrogen peroxide and sodium peroxodisulfate. For polymerization in an aqueous medium it is preferred to use water-soluble initiators.

It is equally possible to use the known redox initiator systems as polymerization initiators. Such redox initiator systems include at least one peroxide compound in combination with a redox coinitiator, examples being reducing sulfur compounds, such as bisulfites, sulfites, thiosulfates, dithionites and tetrathionates of alkali metals and ammonium compounds. For instance, combinations of peroxodisulfates with alkali metal or ammonium hydrogensulfites can be used, e.g., ammonium peroxydisulfate and ammonium disulfite. The amount of the peroxide compound relative to the redox coinitiator is 30:1 to 0.05:1.

In combination with the initiators or redox initiator systems it is possible in addition to use transition metal catalysts, examples being salts of iron, cobalt, nickel, copper, vanadium, and manganese. Examples of suitable salts include iron(II) sulfate, cobalt(II) chloride, nickel(II) sulfate, and copper(I) chloride. Based on monomers, the reducing transition metal salt is used at a concentration of from 0.1 ppm to 1,000 ppm. For instance, combinations of hydrogen peroxide with iron(II) salts can be used, such as 0.5% to 30% of hydrogen peroxide and 0.1 to 500 ppm of Mohr's salt, for example.

Polymerization in organic solvents, too, can be carried out using redox coinitiators and/or transition metal catalysts in combination with the abovementioned initiators, examples of such coinitiators and/or catalysts being benzoin, dimethylaniline, ascorbic acid, and organically soluble complexes of heavy metals such as copper, cobalt, iron, manganese, nickel, and chromium. The amounts of redox coinitiators or transition metal catalysts normally used here are typically about 0.1 to 1 000 ppm, based on the amounts of monomers used.

If the polymerization of the reaction mixture is started at the lower limit of the suitable temperature range for the polymerization and subsequently completed at a higher temperature then it is advantageous to use at least two different initiators which decompose at different temperatures, so that a sufficient concentration of free radicals is available within each temperature interval.

The initiator can also be added in stages, or the rate of initiator addition can be varied over time.

To prepare polymers having a low average molecular weight it is frequently advantageous to conduct the copolymerization in the presence of regulators. For this purpose it is possible to use typical regulators, such as organic SH-containing compounds, such as 2-mercaptoethanol, 2-mercaptopropanol, mercaptoacetic acid, tert-butyl mercaptan, n-octyl mercaptan, n-dodecyl mercaptan and tert-dodecyl mercaptan, C₂ to C₄ aldehydes, such as formaldehyde, acetaldehyde, propionaldehyde, hydroxylammonium salts such as hydroxylammonium sulfate, formic acid, sodium bisulfate or hypophosphorous acid or the salts thereof, or isopropanol, for example. The polymerization regulators are generally used in amounts of 0.1% to 20% by weight, based on the monomers. The average molecular weight can also be influenced by the choice of appropriate solvent. For instance, polymerization in the presence of diluents containing benzylic hydrogen atoms, or in the presence of secondary alcohols such as isopropanol, for example, leads to a reduction in the average molecular weight, as a result of chain transfer.

Polymers of low or relatively low molecular weight are also obtained by varying the temperature and/or the concentration of initiator, and/or the feed rate of the monomers.

In order to prepare higher molecular weight copolymers it is frequently advantageous to operate the polymerization in the presence of crosslinkers. Such crosslinkers are compounds having two or more ethylenically unsaturated groups, such as, for example, diacrylates or dimethacrylates of at least dihydric saturated alcohols, such as ethylene glycol diacrylate, ethylene glycol dimethacrylate, 1,2-propylene glycol diacrylate, 1,2-propylene glycol dimethacrylate, butane-1,4-diol diacrylate, butane-1,4-diol dimethacrylate, hexanediol diacrylate, hexanediol dimethacrylate, neopentyl glycol diacrylate, neopentyl glycol dimethacrylate, 3-methylpentanediol diacrylate and 3-methylpentanediol dimethacrylate. The acrylic and methacrylic esters of alcohols having more than 2 OH groups can also be used as crosslinkers, e.g., trimethylolpropane triacrylate or trimethylolpropane trimethacrylate. A further class of crosslinkers are diacrylates or dimethacrylates of polyethylene glycols or polypropylene glycols having molecular weights of 200 to 9,000 in each case. Polyethylene glycols and polypropylene glycols used for preparing the diacrylates or dimethacrylates preferably have a molecular weight of 400 to 2,000 in each case. As well as the homopolymers of ethylene oxide and/or propylene oxide it is also possible to use block copolymers of ethylene oxide and propylene oxide or copolymers of ethylene oxide and propylene oxide containing the ethylene and propylene oxide units in random distribution. The oligomers of ethylene oxide and/or propylene oxide are suitable as well for preparing the crosslinkers, e.g., diethylene glycol diacrylate, diethylene glycol dimethacrylate, triethylene glycol diacrylate, triethylene glycol dimethacrylate, tetraethylene glycol diacrylate and/or tetraethylene glycol dimethacrylate.

Suitable crosslinkers further include vinyl acrylate, vinyl methacrylate, vinyl itaconate, divinyl adipate, butanediol divinyl ether, trimethylolpropane trivinyl ether, allyl acrylate, allyl methacrylate, pentaerythritol triallyl ether, triallylsucrose, pentaallylsucrose, pentaallylsaccharose, methylenebis(meth)acrylamide, divinylethyleneurea, divinylpropyleneurea, divinylbenzene, divinyldioxane, triallylcyanurate, tetraallylsilane, tetravinylsilane, and bis- or polyacryloylsiloxanes (e.g., Tegomers® from Th. Goldschmidt AG).

The crosslinkers are used preferably in amounts of 0.1% to 30% by weight, based on the monomers to be polymerized, or on the monomers of one stage that are to be polymerized. The crosslinkers can be added in any stage.

It may further be advantageous to stabilize the polymer droplets or polymer particles by means of surface-active auxiliaries. Typically emulsifiers or protective colloids are used for this purpose. Suitable emulsifiers include anionic, nonionic, cationic, and amphoteric emulsifiers. Examples of anionic emulsifiers are alkylbenzenesulfonic acids, sulfonated fatty acids, sulfosuccinates, fatty alcohol sulfates, alkylphenol sulfates, and fatty alcohol ether sulfates. Examples of nonionic emulsifiers that can be used include alkylphenol ethoxylates, primary alcohol ethoxylates, fatty acid ethoxylates, alkanolamide ethoxylates, fatty amine ethoxylates, EO/PO block copolymers, and alkylpolyglucosides. Examples of cationic and amphoteric emulsifiers used include quaternized amine alkoxylates, alkylbetaines, alkylamidobetaines, and sulfobetaines.

Examples of typical protective colloids include cellulose derivatives, polyethylene glycol, polypropylene glycol, copolymers of ethylene glycol and propylene glycol, polyvinyl acetate, polyvinyl alcohol, polyvinyl ethers, starch and starch derivatives, dextran, polyvinylpyrrolidone, polyvinylpyridine, polyethyleneimine, polyvinylimidazole, polyvinylsuccinimide, polyvinyl-2-methylsuccinimide, polyvinyl-1,3-oxazolid-2-one, polyvinyl-2-methylimidazoline, and maleic acid or maleic anhydride copolymers, as described in DE 2 501 123, for example.

The emulsifiers or protective colloids are customarily used in concentrations of 0.05% to 20% by weight, based on the monomers.

If polymerization is carried out in aqueous solution or dilution then the monomers can be wholly or partly neutralized with bases prior to or during the polymerization. Examples of suitable bases include alkali metal and alkaline earth metal compounds such as sodium hydroxide, potassium hydroxide, calcium hydroxide, magnesium oxide, sodium carbonate; ammonia; primary, secondary, and tertiary amines, such as ethylamine, propylamine, monoisopropylamine, monobutylamine, hexylamine, ethanolamine, dimethylamine, diethylamine, di-n-propylamine, tributylamine, triethanolamine, dimethoxyethylamine, 2-ethoxyethylamine, 3-ethoxypropylamine, dimethylethanolamine, diisopropanolamine or morpholine.

Furthermore, neutralization can also be effected using polybasic amines, such as ethylenediamine, 2-diethylaminoethylamine, 2,3-diaminopropane, 1,2-propylenediamine, dimethylaminopropylamine, neopentanediamine, hexamethylenediamine, 4,9-dioxadodecane-1,12-diamine, polyethylenimine or polyvinylamine, for example.

For partial or complete neutralizing of the ethylenically unsaturated carboxylic acids before or during the polymerization it is preferred to use ammonia, triethanolamine, and diethanolamine.

With particular preference the ethylenically unsaturated carboxylic acids are not neutralized prior to and during the polymerization. The polymerization can be conducted continuously or batchwise in accordance with a multiplicity of variants. It is customary to introduce a fraction of the monomers as an initial charge, where appropriate in a suitable diluent or solvent and where appropriate in the presence of an emulsifier, protective colloid or further auxiliaries, to render the atmosphere inert, and to raise the temperature until the desired polymerization temperature is reached. However, the initial charge may also be a suitable diluent alone. The free-radical initiator, further monomers, and other auxiliaries, such as regulators or crosslinkers, for example, each in a diluent, if necessary, are metered in over a defined period of time. The feed times may differ in length. For example, the initiator feed may be run in over a longer time than that chosen for the monomer feed.

If the polymer is prepared in a steam-volatile solvent or solvent mixture, the solvent can be separated off by introducing steam, in order thus to obtain an aqueous solution or dispersion. The polymer can also be separated from the organic diluent by means of a drying operation.

The polymer dispersion (PD) is prepared using at least one α,β-ethylenically unsaturated monomer (M) which is preferably selected from esters of α,β-ethylenically unsaturated monocarboxylic and dicarboxylic acids with C₁-C₂₀ alkanols, vinylaromatics, esters of vinyl alcohol with C₁-C₃₀ monocarboxylic acids, ethylenically unsaturated nitriles, vinyl halides, vinylidene halides, monoethylenically unsaturated carboxylic and sulfonic acids, phosphorus monomers, esters of α,β-ethylenically unsaturated monocarboxylic and dicarboxylic acids with C₂-C₃₀ alkanediols, amides of α,β-ethylenically unsaturated monocarboxylic and dicarboxylic acids with C₂-C₃₀ amino alcohols which contain a primary or secondary amino group, primary amides of α,β-ethylenically unsaturated monocarboxylic acids and their N-alkyl and N,N-dialkyl derivatives, N-vinyllactams, open-chain

N-vinylamide compounds, esters of allyl alcohol with C₁-C₃₀ monocarboxylic acids, esters of α,β-ethylenically unsaturated monocarboxylic and dicarboxylic acids with amino alcohols, amides of α,β-ethylenically unsaturated monocarboxylic and dicarboxylic acids with diamines which contain at least one primary or secondary amino group, N,N-diallylamines, N,N-diallyl-N-alkylamines, vinyl- and allyl-substituted nitrogen heterocycles, vinyl ethers, C₂-C₈-monoolefins, nonaromatic hydrocarbons having at least two conjugated double bonds, polyether (meth)acrylates, monomers containing urea groups, and mixtures thereof.

Suitable esters of α,β-ethylenically unsaturated monocarboxylic and dicarboxylic acids with C₁-C₂₀ alkanols are methyl (meth)acrylate, methyl ethacrylate, ethyl (meth)acrylate, ethyl ethacrylate, n-propyl (meth)acrylate, isopropyl (meth)acrylate, n-butyl (meth)acrylate, sec-butyl (meth)acrylate, tert-butyl (meth)acrylate, tert-butyl ethacrylate, n-hexyl (meth)acrylate, n-heptyl (meth)acrylate, n-octyl (meth)acrylate, 1,1,3,3-tetramethylbutyl (meth)acrylate, ethylhexyl (meth)acrylate, n-nonyl (meth)acrylate, n-decyl (meth)acrylate, n-undecyl (meth)acrylate, tridecyl (meth)acrylate, myristyl (meth)acrylate, pentadecyl (meth)acrylate, palmityl (meth)acrylate, heptadecyl (meth)acrylate, nonadecyl (meth)acrylate, arachinyl (meth)acrylate, behenyl (meth)acrylate, lignoceryl (meth)acrylate, cerotinyl (meth)acrylate, melissinyl (meth)acrylate, palmitoleyl (meth)acrylate, oleyl (meth)acrylate, linolyl (meth)acrylate, linolenyl (meth)acrylate, stearyl (meth)acrylate, lauryl (meth)acrylate, and mixtures thereof.

Preferred vinylaromatics are styrene, 2-methylstyrene, 4-methylstyrene, 2-(n-butyl)styrene, 4-(n-butyl)styrene, 4-(n-decyl)styrene, and, with particular preference, styrene.

Suitable esters of vinyl alcohol with C₁-C₃₀ monocarboxylic acids are, for example, vinyl formate, vinyl acetate, vinyl propionate, vinyl butyrate, vinyl laurate, vinyl stearate, vinyl propionate, Versatic acid vinyl esters, and mixtures thereof.

Suitable ethylenically unsaturated nitriles are acrylonitrile, methacrylonitrile, and mixtures thereof.

Suitable vinyl halides and vinylidene halides are vinyl chloride, vinylidene chloride, vinyl fluoride, vinylidene fluoride, and mixtures thereof.

Suitable ethylenically unsaturated carboxylic acids, sulfonic acids, and phosphonic acids or their derivatives are acrylic acid, methacrylic acid, ethacrylic acid, α-chloroacrylic acid, crotonic acid, maleic acid, maleic anhydride, itaconic acid, citraconic acid, mesaconic acid, glutaconic acid, aconitic acid, fumaric acid, the monoesters of monoethylenically unsaturated dicarboxylic acids having 4 to 10, preferably 4 to 6, C atoms, e.g., monomethyl maleate, vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acids, and 2-acrylamido-2-methylpropanesulfonic acid. Suitable styrenesulfonic acids and derivates thereof are styrene-4-sulfonic acid and styrene-3-sulfonic acid and the alkali metal or alkaline earth metal salts thereof, such as sodium styrene-3-sulfonate and sodium styrene-4-sulfonate, for example. Particularly preferred are acrylic acid, methacrylic acid, and mixtures thereof.

Examples of phosphorus monomers are vinylphosphonic acid and allylphosphonic acid, for example. Also suitable are the monoesters and diesters of phosphonic acid and phosphoric acid with hydroxyalkyl (meth)acrylates, especially the monoesters. Additionally suitable are diesters of phosphonic acid and phosphoric acid that have been esterified once with a hydroxyalkyl (meth)acrylate and also once with a different alcohol, such as an alkanol, for example. Suitable hydroxyalkyl (meth)acrylates for these esters are those specified below as separate monomers, more particularly 2-hydroxyethyl (meth)acrylate, 3-hydroxypropyl (meth)acrylate, 4-hydroxybutyl (meth)acrylate, etc. Corresponding dihydrogen phosphate ester monomers include phosphoalkyl (meth)acrylates, such as 2-phosphoethyl (meth)acrylate, 2-phosphopropyl (meth)acrylate, 3-phosphopropyl (meth)acrylate, phosphobutyl (meth)acrylate, and 3-phospho-2-hydroxypropyl (meth)acrylate. Also suitable are the esters of phosphonic acid and phosphoric acid with alkoxylated hydroxyalkyl (meth)acrylates, examples being the ethylene oxide condensates of (meth)acrylates, such as H₂C=C(CH₃)COO(CH₂CH₂O)ₙP(OH)₂ and H₂C=C(CH₃)COO(CH₂CH₂O)ₙP(=O)(OH)₂, in which n is 1 to 50. Of further suitability are phosphoalkyl crotonates, phosphoalkyl maleates, phosphoalkyl fumarates, phosphodialkyl (meth)acrylates, phosphodialkyl crotonates and allyl phosphates. Further suitable monomers containing phosphorus groups are described in WO 99/25780 and U.S. Pat. No. 4,733,005, which are hereby incorporated by reference.

Suitable esters of α,β-ethylenically unsaturated monocarboxylic and dicarboxylic acids with C₂-C₃₀ alkanediols are, for example, 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate, etc.

Suitable primary amides of α,β-ethylenically unsaturated monocarboxylic acids and their N-alkyl and N,N-dialkyl derivatives are acrylamide, methacrylamide, N-methyl(meth)acrylamide, N-ethyl(meth)acrylamide, N-propyl(meth)acrylamide, N-(n-butyl)(meth)acrylamide, N-(tert-butyl)(meth)acrylamide, N-(n-octyl)(meth)acrylamide, N-(1,1,3,3-tetramethylbutyl)(meth)acrylamide, N-ethylhexyl(meth)acrylamide, N-(n-nonyl)(meth)acrylamide, N-(n-decyl)(meth)acrylamide, N-(n-undecyl)(meth)acrylamide, N-tridecyl(meth)acrylamide, N-myristyl(meth)acrylamide, N-pentadecyl(meth)acrylamide, N-palmityl(meth)acrylamide, N-heptadecyl(meth)acrylamide, N-nonadecyl(meth)acrylamide, N-araquinyl(meth)acrylamide, N-behenyl(meth)acrylamide, N-lignoceryl(meth)acrylamide, N-cerotinyl(meth)acrylamide, N-melissinyl(meth)acrylamide, N-palmitoleyl(meth)acrylamide, N-oleyl(meth)acrylamide, N-linolyl(meth)acrylamide, N-linolenyl(meth)acrylamide, N-stearyl(meth)acrylamide, N-lauryl(meth)acrylamide, N,N-dimethyl(meth)acrylamide, N,N-diethyl(meth)acrylamide, morpholinyl(meth)acrylamide.

Suitable N-vinyllactams and their derivatives are, for example, N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam, etc.

Suitable open-chain N-vinylamide compounds are, for example, N-vinylformamide, N-vinyl-N-methylformamide, N-vinylacetamide, N-vinyl-N-methylacetamide, N-vinyl-N-ethylacetamide, N-vinylpropionamide, N-vinyl-N-methylpropionamide, and N-vinylbutyramide.

Suitable esters of α,β-ethylenically unsaturated monocarboxylic and dicarboxylic acids with amino alcohols are N,N-dimethylaminomethyl (meth)acrylate, N,N-dimethylaminoethyl (meth)acrylate, N,N-diethylaminoethylacrylate, N,N-dimethylaminopropyl (meth)acrylate, N,N-diethylaminopropyl (meth)acrylate, and N,N-dimethylaminocyclohexyl (meth)acrylate.

Suitable amides of α,β-ethylenically unsaturated monocarboxylic and dicarboxylic acids with diamines which contain at least one primary or secondary amino group are N-[2-(dimethylamino)ethyl]acrylamide, N[2-(dimethylamino)ethyl]methacrylamide, N-[3-(dimethylamino)propyl]acrylamide, N-[3-(dimethylamino)propyl]methacrylamide, N-[4-(dimethylamino)butyl]acrylamide, N[4-(dimethylamino)butyl]methacrylamide, N-[2-(diethylamino)ethyl]acrylamide, N-[4-(dimethylamino)cyclohexyl]acrylamide, N[4-(dimethylamino)cyclohexyl]methacrylamide, etc.

Suitable monomers M) are, furthermore, N,N-diallylamines and N,N-diallyl-N-alkylamines and their acid addition salts and quaternization products. Alkyl here is preferably C₁-C₂₄ alkyl. Preference is given to N,N-diallyl-N-methylamine and to N,N-diallyl-N,N-dimethylammonium compounds, such as the chlorides and bromides, for example.

Further suitable monomers M) are vinyl- and allyl-substituted nitrogen heterocycles, such as N-vinylimidazole, N-vinyl-2-methylimidazole, and vinyl- and allyl-substituted heteroaromatic compounds, such as 2- and 4-vinylpyridine, 2- and 4-allylpyridine, and the salts thereof.

Suitable C₂-C₈ monoolefins and nonaromatic hydrocarbons having at least two conjugated double bonds are, for example, ethylene, propylene, isobutylene, isoprene, butadiene, etc.

Examples of suitable monomers containing urea groups are N-vinylurea or N-allylurea or derivatives of imidazolidin-2-one. They include N-vinyl- and N-allylimidazolidin-2-one, N-vinyl oxyethylimidazolidin-2-one, N-(2-(meth)acrylamidoethyl)imidazolidin-2-one, N-(2-(meth)acryloxyethyl)imidazolidin-2-one (i.e., 2-ureido (meth)acrylate), N-[2-((meth)acryloxyacetamido)ethyl]imidazolidin-2-one, etc.

Preferred monomers containing urea groups are N-(2-acryloxyethyl)imidazolidin-2-one and N-(2-methacryloxyethyl)imidazolidin-2-one. Particular preference is given to N-(2-methacryloxyethyl)imidazolidin-2-one (2-ureidomethacrylate, UMA).

Further suitable monomers M) are alkyd resins, epoxy resins, polyester resins, polyurethanes or polyvinyl chlorides.

The aforementioned monomers (M) may be used individually, in the form of mixtures within one class of monomer, or in the form of mixtures from different classes of monomer.

Particularly suitable monomer combinations for the aqueous dispersion of the film-forming polymer (PD) are, for example, n-butyl acrylate with vinyl acetate; n-butyl acrylate with styrene; n-butyl acrylate with ethylhexyl acrylate; butadiene with styrene; butadiene with acrylonitrile and/or methacrylonitrile; butadiene and isoprene with acrylonitrile and/or methacrylonitrile; butadiene with acrylic esters; butadiene with methacrylic esters. All of the stated monomer combinations may, furthermore, comprise small amounts of further monomers, preferably acrylic acid, methacrylic acid, acrylamide and/or methacrylamide.

One preferred preparation process for the inventive dispersion of the film-forming polymer (PD) is described in EP 939 774, whose content is hereby incorporated in full by reference.

The blends of the invention are employed preferably in aqueous paints. These paints take the form, for example, of an unpigmented system (clear varnish) or of a pigmented system. The fraction of the pigments can be described by the pigment volume concentration (PVC). The PVC describes the ratio of the volume of pigments (Vₚ) and fillers (V_{F}) to the total volume, composed of the volumes of binder (V_{B}), pigments, and fillers of a dried coating film, in percent: PVC=(Vₚ+V_{F})×100/(Vₚ+V_{F}+V_{B}). Coating materials can be classified on the basis of the PVC, for example, as follows:

| | | |
|---|---|---|
| highly filled interior paint, wash resistant, white/matt | about | 85 |
| interior paint, scrub resistant, white/matt | about | 80 |
| semigloss paint, silk-matt | about | 35 |
| semigloss paint, silk-gloss | about | 25 |
| high-gloss paint | about | 15-25 |
| exterior masonry paint, white | about | 45-55 |

| | |
|---|---|
| clear varnish | 0 |

The invention provides further a coating material in the form of an aqueous composition, comprising:

a blend of at least one inventive aqueous dispersion of hollow organic particles, and of at least one inventive aqueous dispersion of a film-forming polymer (PD),

if desired, at least one inorganic filler and/or inorganic pigment,

typical auxiliaries, and

water to 100% by weight.

Preference is given to a coating material comprising:

3% to 60% by weight, based on the solids content, of a blend of at least one inventive aqueous dispersion of hollow organic particles, and of at least one inventive aqueous dispersion of a film-forming polymer (PD) as defined above,

10% to 70% by weight of inorganic fillers and/or inorganic pigments,

0.1% to 20% by weight of typical auxiliaries, and

water to 100% by weight.

The fraction of (PD) as a proportion of the above coating material is based on solids, i.e., emulsion polymer, without water.

The coating materials of the invention, in the form of an aqueous composition, are employed preferably as paints. One embodiment are paints in the form of a clear varnish. Another embodiment are paints in the form of an emulsion paint.

Elucidated in the text below is the composition of a typical emulsion paint. Emulsion paints comprise generally 30% to 75% by weight and preferably 40% to 65% by weight of nonvolatile constituents. By these are meant all constituents of the preparation which are not water, but at least the total amount of binder, filler, pigment, low-volatility solvents (boiling point above 220° C.), plasticizers for example, and polymeric auxiliaries. This figure is accounted for to the extent of about

a) 3% to 90%, more particularly 10% to 60%, by weight, by the blend of at least one inventive aqueous dispersion of hollow organic particles, and of at least one inventive aqueous dispersion of a film-forming polymer (PD) as defined above,

b) 0% to 85%, preferably 5% to 60%, more particularly 10% to 50%, by weight, by at least one inorganic pigment,

c) 0% to 85%, more particularly 5% to 60%, by weight, by inorganic fillers, and

d) 0.1% to 40%, more particularly 0.5% to 20%, by weight, by typical auxiliaries.

The polymer dispersions of the invention are suitable more preferably for producing interior and exterior paints. These paints are characterized generally by a pigment volume concentration, PVC, in the range from 30 to 65 for masonry paints and by a PVC in the range from 65 to 80 for interior paints.

By the pigment volume concentration PVC here is meant the ratio, multiplied by 100, of the total volume of pigments plus fillers divided by the total volume of pigments, fillers, and binder polymers; cf. Ullmann's Enzyklopädie der technischen Chemie, 4th edition, volume 15, p. 667.

The term “pigment” is used in the context of this invention comprehensively to identify all pigments and fillers, examples being color pigments, white pigments, and inorganic fillers. These include inorganic white pigments such as titanium dioxide, preferably in the rutile form, barium sulfate, zinc oxide, zinc sulfide, basic lead carbonate, antimony trioxide, lithopones (zinc sulfide+barium sulfate), or colored pigments, examples being iron oxides, carbon black, graphite, zinc yellow, zinc green, ultramarine, manganese black, antimony black, manganese violet, Paris blue or Schweinfurt green. Besides the inorganic pigments the emulsion paints of the invention may also comprise organic color pigments, examples being sepia, gamboge, Cassel brown, toluidine red, para red, Hansa yellow, indigo, azo dyes, anthraquinonoid and indigoid dyes, and also dioxazine, quinacridone, phthalocyanine, isoindolinone, and metal complex pigments. Also suitable are synthetic white pigments with air inclusions to increase the light scattering, such as the Rhopaque® dispersions.

Suitable fillers are, for example, aluminosilicates, such as feldspars, silicates, such as kaolin, talc, mica, magnesite, alkaline earth metal carbonates, such as calcium carbonate, in the form for example of calcite or chalk, magnesium carbonate, dolomite, alkaline earth metal sulfates, such as calcium sulfate, silicon dioxide, etc. Finely divided fillers are of course preferred in paints. The fillers can be used as individual components. In actual practice, however, filler mixtures have proven particularly appropriate, examples being calcium carbonate/kaolin and calcium carbonate/talc. Glossy paints generally include only small amounts of very finely divided fillers, or comprise no fillers.

Finely divided fillers may also be used to increase the hiding power and/or to save on the use of white pigments. In order to adjust the hiding power of the hue and the depth of color, it is preferred to use blends of color pigments and fillers.

The typical auxiliaries, in addition to the emulsifiers used in the polymerization, include wetting agents or dispersants, such as sodium, potassium or ammonium polyphosphates, alkali metal salts and ammonium salts of acrylic acid copolymers or maleic anhydride copolymers, polyphosphonates, such as sodium 1-hydroxyethane-1,1-diphosphonate, and salts of naphthalenesulfonic acids, more particularly their sodium salts.

Further suitable auxiliaries are flow control agents, defoamers, biocides, and thickeners. Suitable thickeners are, for example, associative thickeners, such as polyurethane thickeners. The amount of the thickener is preferably less than 1% by weight, more preferably less than 0.6% by weight, of thickener, based on solids content of the paint.

The paints of the invention are produced in a known way by blending the components in mixing apparatus customary for the purpose. It has been found appropriate to prepare an aqueous paste or dispersion from the pigments, water, and, if appropriate, the auxiliaries, and only then to mix the polymeric binder, i.e., in general, the aqueous dispersion of the polymer, with the pigment paste or pigment dispersion.

The paints of the invention comprise generally 30% to 75% by weight and preferably 40% to 65% by weight of nonvolatile constituents. By these are meant all constituents of the preparation which are not water, but at least the total amount of binder, pigment, and auxiliary, based on the solids content of the paint. The volatile constituents are primarily water.

The paint of the invention may be applied to substrates in a typical way, as for example by spreading, spraying, dipping, rolling, knife coating, etc.

It is used preferably as an architectural coating material, i.e., for coating buildings or parts of buildings. The substrates in question may be mineral substrates such as renders, plaster or plasterboard, masonry or concrete, wood, woodbase materials, metal or paper, wallpaper for example, or plastic, PVC for example.

The paint is used preferably for internal parts of buildings or for facades.

The paints of the invention feature ease of handling and good processing properties, such as good wet abrasion resistance and high hiding power. Their pollutant content is low. They have good performance properties, such as high water resistance, good wet adhesion, not least on alkyd paints, high blocking resistance, good recoatability, and good flow on application. The equipment used is easily cleaned with water.

The invention is elucidated in more detail with reference to the following, nonlimiting examples.

### EXPERIMENTAL METHODS

Determination of Glass Transition Temperature p The glass transition temperatures were determined by theoretical calculation using the Fox equation (John Wiley & Sons Ltd., Baffins Lane, Chichester, England, 1997).

1/Tg =Wa/T_{g}a +WbIT_{g}b, where
T_{ga} and T_{gb}=glass transition temperature of polymer “a” and “b”
Wₐ and W_{b} =weight fraction of polymer “a” and “b”

### Measurement of Particle Size

The particle sizes were determined using a Coulter M4+ (Particle Analyzer) or by means of photon correlation spectroscopy, also known as quasielastic light scattering or dynamic light scattering (ISO 13321 standard) using an HPPS (High Performance Particle Sizer) from Malvern, or by means of hydrodynamic fractionation using a PSDA (Particle Size Distribution Analyzer) from Polymer Labs, or by means of AUC (Analytical Ultracentrifuge).

### Wet Abrasion Resistance

To test the wet abrasion resistance, the paint under test was drawn down onto a sheet, using a film-drawing apparatus, with a defined thickness. After seven days' drying at room temperature and two days' at 50° C., the coated sheet was subjected to 200 scrub cycles in a scrub tester, and the loss of film was calculated in micrometers. The test took place along the lines of DIN EN ISO 11998.

### Spreading Rate

A sheet with a standardized surface with black and white sectors was weighed. The paint was applied to the weighed sheets using a film-drawing apparatus, in wet film thicknesses of 150, 200, and 240 μm. The freshly coated sheets were weighed again and then dried at 23° C. and 50% humidity for 24 hours. Thereafter the contrast ratio of all of the draw downs was measured using a Byk Gardner Spectrophotometer having a so-called gloss trap. This measurement was carried out at five measurement points on three black sectors (Ys values) and three white sectors (Yw values). The contrast ratio was determined by forming the ratio Ys/Yw*100 [%] of the average values Yw and Ys. The spreading rate was subsequently determined, in m2/L, at 98% contrast ratio, taking into account the specific density of the paint and the amount of paint applied in each case.

### Procedure for Measuring the Whiteness

6 g of the color paste described below and 1 g of the approximately 30% dispersion of hollow particles are weighed out into a vessel and the mixture is homogenized without stirred incorporation of air. A film of this mixture is drawn down using a 200 μm doctor blade at a rate of 0.9 cm/sec onto a black plastic film (matt finish, Article No. 13.41 EG 870934001, Bernd Schwegmann GmbH & Co. KG, D). The samples are dried at 23° C. and a relative humidity of 40-50% for 24 h. Subsequently the whiteness is measured in three different places using a Minolta CM-508i spectrophotometer. The measurement points are marked in order to allow subsequent measurement, using a micrometer screw, of the corresponding thicknesses of the paint film by differential measurement relative to the uncoated plastic film. Following calculation of an average film thickness and also of an average whiteness from the three individual measurements, the resulting whiteness is, finally, standardized to a dry film thickness of 50 μm by means of linear extrapolation. The calibration required for this purpose was carried out by measuring the whiteness of a standard hollow particle dispersion in a dry film thickness range of approximately 30-60 μm.

### Preparation of Color Paste

A) A vessel is charged with 240 g of water, after which the following ingredients are added in the stated order, with a dissolver running at about 1000 rpm, and the mixture is stirred for a total of about 15 minutes until homogeneous: 2.5 g of Natrosol® 250 HR (hydroxyethylcellulose thickener from Hercules GmbH), 1 g of 10% strength sodium hydroxide solution, 6 g of Pigmentverteiler® MD 20 (pigment-dispersing copolymer of maleic acid and diisobutylene from BASF AG), 10 g of Collacral® LR 8990 (polyurethane associative thickener from BASF AG), 3 g of Agitan® E 255 (siloxane defoamer from Munzing Chemie GmbH), 2 g of Proxel® BD 20 (biocide from Avecia Inc.), 370 g of Acronal® A 684 (binder, 50% dispersion from BASF AG), 20 g of Texanol® (film-forming assistant from Eastman Chemical Company), 2 g of Agitan® E 255 (siloxane defoamer from Münzing Chemie GmbH), and 10 g of 5% strength Collacral LR 8989 (polyurethane associative thickener from BASF AG).
B) A vessel is charged with 250 g of water, after which the following ingredients are added in the stated order, with a dissolver running at about 1000 rpm, and the mixture is stirred for a total of about 15 minutes until homogeneous: 2.5 g of Natrosol® 250 HR (hydroxyethylcellulose thickener from Hercules GmbH), 1 g of 10% strength sodium hydroxide solution, 6 g of Pigmentverteiler®

MD 20 (pigment-dispersing copolymer of maleic acid and diisobutylene from BASF AG), 10 g of Collacral® LR 8990 (polyurethane associative thickener from BASF AG), 3 g of Agitan® E 255 (siloxane defoamer from Münzing Chemie GmbH), 2 g of Proxel® BD 20 (biocide from Avecia Inc.), 203 g of Kronos 2300, 370 g of Acronal® A 684 (binder, 50% dispersion from BASF AG), 20 g of Texanol® (film-forming assistant from Eastman Chemical Company), 2 g of Agitan® E 255 (siloxane defoamer from Münzing Chemie GmbH), 10 g of 5% strength Collacral LR 8989 (polyurethane associative thickener from BASF AG), and 116 g of hollow particle dispersion.

### EXAMPLES

Preparation of the Dispersion of the Hollow Organic Particles

The inventive preparation process for the aqueous dispersion of the hollow organic particles is disclosed through the sequential ordering of a plurality of individual steps. First the preparation of dispersion A, then the reaction of dispersion A, in which dispersion B is obtained, and subsequently the reaction of this dispersion B, leading to dispersion C.

Dispersion A (seed)

From 230 g of water, 2.17 g of arylsulfonate (15% strength), 338 g of n-butyl acrylate, 303.6 g of methyl methacrylate and 8.45 g of methacrylic acid a preemulsion was prepared. The initial charge, consisting of 2356 g of water, 32.0 g of arylsulfonate (15% strength) and 41.2 g of the preemulsion, was heated to a temperature of 80° C. under a nitrogen atmosphere in a polymerization vessel equipped with an anchor stirrer, reflux condenser and two feed vessels and, following the addition of 14 g of a 22.4% strength solution of ammonium persulfate, polymerization was commenced for 15 minutes. Then the remainder of the preemulsion was metered in over the course of 60 minutes at 80° C. Subsequently polymerization was continued for 15 minutes and the reaction mixture then cooled to 55° C. over the course of 20 minutes. For depletion of residual monomers 6.5 g of a 10% strength solution of tert-butyl hydroperoxide and 8.1 g of a 5% strength solution of Rongalit C were then added to the reaction mixture, and after cooling to 30° C. the pH of the dispersion was adjusted by addition of 8.1 g of 25% strength ammonia solution.

Solids content: 19.7%
pH: 2.6
Particle size (AUC, D50): 47 nm
Dispersion B1 (swell core)

The initial charge, consisting of 1455 g of water and 63.2 g of dispersion A, was heated to a temperature of 79° C. under a nitrogen atmosphere in a polymerization vessel equipped with an anchor stirrer, reflux condenser and two feed vessels and, following the addition of 10 g of a 2.5% strength solution of sodium persulfate, polymerization was commenced for 5 minutes. Then preemulsion 1, consisting of 262 g of water, 3.33 g of arylsulfonate (15% strength), 20.75 g of Lutensit A-EP (acid form, 20% strength), 186.6 g of methyl methacrylate and 124.4 g of methacrylic acid, was metered in over the course of 113 minutes at 79° C. Subsequently preemulsion 2, consisting of 254 g of water, 2.67 g of arylsulfonate (15% strength), 187 g of methyl methacrylate and 2.05 g of methacrylic acid, was metered in together with 22 g of a 2.5% strength solution of sodium persulfate over the course of 67 minutes at 79° C. Finally polymerization was continued for 30 minutes.

Solids content: 19.9%

pH: 2.5

Particle size (Autosizer): 195 nm
Dispersion B2 (swell core)

The initial charge, consisting of 1455 g of water and 42.0 g of dispersion A, was heated to a temperature of 79° C. under a nitrogen atmosphere in a polymerization vessel equipped with an anchor stirrer, reflux condenser and two feed vessels and, following the addition of 10 g of a 2.5% strength solution of sodium persulfate, polymerization was commenced for 5 minutes. Then preemulsion 1, consisting of 262 g of water, 3.33 g of arylsulfonate (15% strength), 20.75 g of Lutensit A-EP (acid form, 20% strength), 211.8 g of methyl methacrylate and 104.3 g of methacrylic acid, was metered in over the course of 113 minutes at 79° C. Subsequently preemulsion 2, consisting of 254 g of water, 2.67 g of arylsulfonate (15% strength), 186 g of methyl methacrylate and 2.05 g of methacrylic acid, was metered in together with 22 g of a 2.5% strength solution of sodium persulfate over the course of 67 minutes at 79° C. Finally polymerization was continued for 30 minutes.

Solids content: 19.7%
Particle size (Autosizer): 211 nm
Dispersion B3 (swell core)

The initial charge, consisting of 1009 g of water and 28.7 g of Acronal A 508, was heated to a temperature of 82° C. under a nitrogen atmosphere in a polymerization vessel equipped with an anchor stirrer, reflux condenser and two feed vessels and, following the addition of 20.2 g of a 2.5% strength solution of sodium persulfate, polymerization was commenced for 5 minutes. Then preemulsion 1, consisting of 163 g of water, 2.24 g of arylsulfonate (15% strength), 13.95 g of Lutensit A-EPA (partly neutralized, 20% strength), 124.9 g of methyl methacrylate, 83.6 g of methacrylic acid and 0.50 g of allyl methacrylate, was metered in over the course of 70 minutes at 82° C. After the end of the feed, 3.0 g of a 2.5% strength solution of sodium persulfate were added and the mixture was stirred for 5 minutes. Subsequently preemulsion 2, consisting of 171 g of water, 1.79 g of arylsulfonate (15% strength), 112 g of methyl methacrylate, 13.8 g of n-butyl acrylate and 1.38 g of methacrylic acid, was metered in together with 12 g of a 2.5% strength solution of sodium persulfate over the course of 70 minutes at 82° C. Finally polymerization was continued for 30 minutes.

Solids content: 19.8%
pH: 4.4
Particle size (Autosizer): 207 nm
Dispersion B4 (swell core)

The initial charge, consisting of 1542 g of water and 44.2 g of dispersion A, was heated to a temperature of 82° C. under a nitrogen atmosphere in a polymerization vessel equipped with an anchor stirrer, reflux condenser and two feed vessels and, following the addition of 10.6 g of a 2.5% strength solution of sodium persulfate, polymerization was commenced for 5 minutes. Then preemulsion 1, consisting of 277 g of water, 3.53 g of arylsulfonate (15% strength), 22.00 g of Lutensit A-EP (acid form, 20% strength), 222.6 g of methyl methacrylate and 109.7 g of methacrylic acid, was metered in over the course of 113 minutes, during which the polymerization temperature was lowered continuously from 82° C. to 80° C. Subsequently preemulsion 2, consisting of 269 g of water, 2.83 g of arylsulfonate (15% strength), 196 g of methyl methacrylate and 2.17 g of methacrylic acid, was metered in together with 23 g of a 2.5% strength solution of sodium persulfate over the course of 67 minutes at 80° C. Finally polymerization was continued for 30 minutes.

Solids content: 19.7%
pH: 2.7
Particle size (Autosizer): 215 nm
Dispersion B5 (swell core)

The initial charge, consisting of 1009 g of water and 28.7 g of Acronal A 508, was heated to a temperature of 82° C. under a nitrogen atmosphere in a polymerization vessel equipped with an anchor stirrer, reflux condenser and two feed vessels and, following the addition of 20.2 g of a 2.5% strength solution of sodium persulfate, polymerization was commenced for 5 minutes. Then preemulsion 1, consisting of 163 g of water, 2.24 g of arylsulfonate (15% strength), 13.95 g of Lutensit A-EPA (partly neutralized, 20% strength), 125.0 g of methyl methacrylate, 83.6 g of methacrylic acid and 0.34 g of allyl methacrylate, was metered in over the course of 70 minutes at 82° C. After the end of the feed, 3.0 g of a 2.5% strength solution of sodium persulfate were added and the mixture was stirred for 5 minutes. Subsequently preemulsion 2, consisting of 171 g of water, 1.79 g of arylsulfonate (15% strength), 112 g of methyl methacrylate, 13.8 g of n-butyl acrylate and 1.38 g of methacrylic acid, was metered in together with 12 g of a 2.5% strength solution of sodium persulfate over the course of 70 minutes at 82° C. Finally polymerization was continued for 30 minutes.

Solids content: 19.8%
pH: 4.4
Particle size (Autosizer): 220 nm
Dispersion B6 (swell core)

The initial charge, consisting of 1613 g of water and 45.2 g of Acronal A 508, was heated to a temperature of 82° C. under a nitrogen atmosphere in a polymerization vessel equipped with an anchor stirrer, reflux condenser and two feed vessels and, following the addition of 10.6 g of a 2.5% strength solution of sodium persulfate, polymerization was commenced for 5 minutes. Then preemulsion 1, consisting of 127 g of water, 1.77 g of arylsulfonate (15% strength), 11.13 g of Lutensit A-EPA (partly neutralized, 20% strength), 99.1 g of methyl methacrylate and 65.7 g of methacrylic acid, was metered in over the course of 70 minutes at 82° C. At the same time preemulsion 2, consisting of 127 g of water, 1.77 g of arylsulfonate (15% strength), 11.13 g of Lutensit A-EPA (partly neutralized, 20% strength), 110.1 g of methyl methacrylate, 54.2 g of methacrylic acid and 0.53 g of allyl methacrylate, was metered over the course of 70 minutes into preemulsion 1 (power feed mode). After the end of the feeds, 4.7 g of a 2.5% strength solution of sodium persulfate were added and the mixture was stirred for 5 minutes. Subsequently preemulsion 3, consisting of 269 g of water, 2.83 g of arylsulfonate (15% strength), 176 g of methyl methacrylate and 21.7 g of n-butyl acrylate and 2.17 g of methacrylic acid, was metered in together with 19 g of a 2.5% strength solution of sodium persulfate over the course of 70 minutes at 82° C. Finally polymerization was continued for 30 minutes.

Solids content: 19.8%
pH: 4.3
Particle size (Autosizer): 210 nm

Dispersion B7 (swell core)

The initial charge, consisting of 1589 g of water and 45.2 g of Acronal A 508, was heated to a temperature of 82° C. under a nitrogen atmosphere in a polymerization vessel equipped with an anchor stirrer, reflux condenser and two feed vessels and, following the addition of 10.6 g of a 2.5% strength solution of sodium persulfate, polymerization was commenced for 5 minutes. Then preemulsion 1, consisting of 277 g of water, 3.53 g of arylsulfonate (15% strength), 22.00 g of Lutensit A-EPA (partly neutralized, 20% strength), 222.1 g of methyl methacrylate, 0.53 g of allyl methacrylate and 109.7 g of methacrylic acid, was metered in over the course of 70 minutes at 82° C. After the end of the feed, 4.7 g of a 2.5% strength solution of sodium persulfate were added and the mixture was stirred for 5 minutes. Subsequently preemulsion 2, consisting of 269 g of water, 2.83 g of arylsulfonate (15% strength), 196 g of methyl methacrylate and 2.17 g of methacrylic acid, was metered in together with 23 g of a 2.5% strength solution of sodium persulfate over the course of 70 minutes at 82° C. Finally polymerization was continued for 30 minutes.

Solids content: 19.7%
pH: 4.8
Particle size (Autosizer): 209 nm
Dispersion B8 (swell core)

The initial charge, consisting of 986 g of water and 28.2 g of Acronal A 508, was heated to a temperature of 82° C. under a nitrogen atmosphere in a polymerization vessel equipped with an anchor stirrer, reflux condenser and two feed vessels and, following the addition of 20.9 g of a 2.5% strength solution of sodium persulfate, polymerization was commenced for 5 minutes. Then preemulsion 1, consisting of 161 g of water, 2.20 g of arylsulfonate (15% strength), 13.70 g of Lutensit A-EPA (partly neutralized, 20% strength), 0.07 g of tert-dodecyl mercaptan, 136.3 g of methyl methacrylate, 0.66 g of allyl methacrylate and 68.3 g of methacrylic acid, was metered in over the course of 70 minutes at 82° C. After the end of the feed, 2.9 g of a 2.5% strength solution of sodium persulfate were added and the mixture was stirred for 5 minutes. Subsequently preemulsion 2, consisting of 167 g of water, 1.76 g of arylsulfonate (15% strength), 110 g of methyl methacrylate, 13.5 g of n-butyl acrylate and 1.35 g of methacrylic acid, was metered in together with 12 g of a 2.5% strength solution of sodium persulfate over the course of 70 minutes at 82° C. Finally polymerization was continued for 30 minutes.

Solids content: 19.7%
pH: 4.3
Particle size (Autosizer): 213 nm

### Dispersion C1:

The initial charge, consisting of 513 g of water and 158.3 g of dispersion B1,was heated to a temperature of 80° C. under a nitrogen atmosphere in a polymerization vessel equipped with an anchor stirrer, reflux condenser and two feed vessels and, following addition of 14.4 g of a 2.5% strength solution of sodium persulfate, polymerization was commenced for 5 minutes. Then preemulsion 1, consisting of 158 g of water, 6.6 g of arylsulfonate (15% strength), 11.3 g of methacrylic acid and 180 g of styrene, was metered in together with 18.3 g of a 2.5% strength solution of sodium persulfate over the course of 80 minutes initially at 80° C.; toward the end of the feed the internal temperature was raised to 92° C. and the sodium persulfate feed was stopped. After the end of the emulsion feed preemulsion 2, consisting of 16 g of water, 0.6 g of arylsulfonate (15% strength) and 15.8 g of a-methylstyrene, was added and the mixture was stirred for 5 minutes, followed by the addition of 30 g of 10% strength aqueous ammonia; the reaction mixture was stirred at 92° C. for a further 15 minutes. Subsequently 4.0 g of a 2.5% strength solution of sodium persulfate were metered in over the course of 3 minutes. Preemulsion 3, consisting of 210 g of water, 7.5 g of arylsulfonate (15% strength), 22.5 g of methyl methacrylate and 221 g of styrene, was metered in together with 27.4 g of a 2.5% strength solution of sodium persulfate over the course of 100 minutes at 92° C. Finally polymerization was continued for 30 minutes. Residual monomers were reduced by a final chemical deodorization. For this purpose 13.5 g of a 10% strength solution of tert-butyl hydroperoxide and 13.5 g of a 10% strength solution of ascorbic acid were metered in parallel into the reaction mixture over the course of 60 minutes at 92° C.

Solids content: 29.9%
pH: 7.6
Further inventive hollow particle dispersions:

### Dispersion C2a:

The initial charge, consisting of 501 g of water and 152.0 g of dispersion B2, was heated to a temperature of 80° C. under a nitrogen atmosphere in a polymerization vessel equipped with an anchor stirrer, reflux condenser and two feed vessels and, following addition of 14.4 g of a 2.5% strength solution of sodium persulfate, polymerization was commenced for 5 minutes. Then preemulsion 1, consisting of 158 g of water, 6.6 g of arylsulfonate (15% strength), 9.7 g of methacrylic acid and 155 g of styrene, was metered in together with 16.7 g of a 2.5% strength solution of sodium persulfate over the course of 80 minutes initially at 80° C.; toward the end of the feed the internal temperature was raised to 92° C. and the sodium persulfate feed was stopped.

After the end of the emulsion feed preemulsion 2, consisting of 16 g of water, 0.6 g of arylsulfonate (15% strength) and 13.5 g of a-methylstyrene, was added and the mixture was stirred for 5 minutes, followed by the addition of 26 g of 10% strength aqueous ammonia; the reaction mixture was stirred at 92° C. for a further 15 minutes. Subsequently 4.0 g of a 2.5% strength solution of sodium persulfate were metered in over the course of 3 minutes. Preemulsion 3, consisting of 229 g of water, 7.5 g of arylsulfonate (15% strength), 25.2 g of methyl methacrylate and 247 g of styrene, was metered in together with 29.0 g of a 2.5% strength solution of sodium persulfate over the course of 100 minutes at 92° C. Finally polymerization was continued for 30 minutes. Residual monomers were reduced by a final chemical deodorization. For this purpose 13.5 g of a 10% strength solution of tert-butyl hydroperoxide and 13.5 g of a 10% strength solution of ascorbic acid were metered in parallel into the reaction mixture over the course of 60 minutes at 92° C.

Solids content: 28.5%
pH: 8.7
Particle size (Autosizer): 731 nm (0.13 polydispersity)

### Whiteness: 74

### Dispersion C2b:

The initial charge, consisting of 486 g of water and 174.7 g of dispersion B2, was heated to a temperature of 80° C. under a nitrogen atmosphere in a polymerization vessel equipped with an anchor stirrer, reflux condenser and two feed vessels and, following addition of 14.4 g of a 2.5% strength solution of sodium persulfate, polymerization was commenced for 5 minutes. Then preemulsion 1, consisting of 179 g of water, 7.5 g of arylsulfonate (15% strength), 11.0 g of methacrylic acid and 176 g of styrene, was metered in together with 18.9 g of a 2.5% strength solution of sodium persulfate over the course of 90 minutes initially at 80° C.; toward the end of the feed the internal temperature was raised to 92° C. and the sodium persulfate feed was stopped. After the end of the emulsion feed preemulsion 2, consisting of 16 g of water, 0.6 g of arylsulfonate (15% strength) and 15.3 g of a-methylstyrene, was added and the mixture was stirred for 5 minutes, followed by the addition of 29 g of 10% strength aqueous ammonia; the reaction mixture was stirred at 92° C. for a further 15 minutes. Subsequently 4.0 g of a 2.5% strength solution of sodium persulfate were metered in over the course of 3 minutes. Preemulsion 3, consisting of 207 g of water, 6.6 g of arylsulfonate (15% strength), 22.7 g of methyl methacrylate and 225 g of styrene, was metered in together with 26.7 g of a 2.5% strength solution of sodium persulfate over the course of 90 minutes at 92° C. Finally polymerization was continued for 30 minutes. Residual monomers were reduced by a final chemical deodorization. For this purpose 13.5 g of a 10% strength solution of tert-butyl hydroperoxide and 13.5 g of a 10% strength solution of ascorbic acid were metered in parallel into the reaction mixture over the course of 60 minutes at 92° C.

Solids content: 29.3%
pH: 8.7
Particle size (Autosizer): 719 nm (0.18 PD)

### Whiteness: 70

### Dispersion C3:

The initial charge, consisting of 486 g of water and 181.2 g of dispersion B3, was heated to a temperature of 82° C. under a nitrogen atmosphere in a polymerization vessel equipped with an anchor stirrer, reflux condenser and two feed vessels and, following addition of 14.4 g of a 2.5% strength solution of sodium persulfate, polymerization was commenced for 5 minutes. Then preemulsion 1, consisting of 179 g of water, 7.5 g of arylsulfonate (15% strength), 11.0 g of methacrylic acid and 176 g of styrene, was metered in together with 18.9 g of a 2.5% strength solution of sodium persulfate over the course of 90 minutes at 82° C. After the end of both feeds, the internal temperature was raised to 92° C. over the course of 30 minutes and then preemulsion 2, consisting of 16 g of water, 0.6 g of arylsulfonate (15% strength) and 15.3 g of α-methylstyrene, was added and the mixture was stirred for 5 minutes, followed by the addition of 29 g of 10% strength aqueous ammonia; the reaction mixture was stirred at 92° C. for a further 15 minutes. Subsequently 4.0 g of a 2.5% strength solution of sodium persulfate were metered in over the course of 3 minutes. Preemulsion 3, consisting of 177 g of water, 6.6 g of arylsulfonate (15% strength), 22.7 g of methyl methacrylate and 223 g of styrene, was metered in together with 26.7 g of a 2.5% strength solution of sodium persulfate over the course of 115 minutes at 92° C. After a feed time of 55 minutes, 32.1 g of 7% strength itaconic acid were added to preemulsion 3. Finally polymerization was continued for 30 minutes. Residual monomers were reduced by a final chemical deodorization. For this purpose 13.5 g of a 10% strength solution of tert-butyl hydroperoxide and 13.5 g of a 10% strength solution of ascorbic acid were metered in parallel into the reaction mixture over the course of 60 minutes at 92° C.

Solids content: 29.1%
pH: 7.0
Particle size (Autosizer): 519 nm (0.09 PD)

### Whiteness: 73

### Dispersion C4:

The initial charge, consisting of 431 g of water and 155.3 g of dispersion B4, was heated to a temperature of 80° C. under a nitrogen atmosphere in a polymerization vessel equipped with an anchor stirrer, reflux condenser and two feed vessels and, following addition of 12.8 g of a 2.5% strength solution of sodium persulfate, polymerization was commenced for 5 minutes. Then preemulsion 1, consisting of 159 g of water, 6.7 g of arylsulfonate (15% strength), 9.8 g of methacrylic acid and 156 g of styrene, was metered in together with 16.8 g of a 2.5% strength solution of sodium persulfate over the course of 90 minutes initially at 80° C.; toward the end of the feed the internal temperature was raised to 92° C. and the sodium persulfate feed was stopped. After the end of the emulsion feed preemulsion 2, consisting of 14 g of water, 0.5 g of arylsulfonate (15% strength) and 13.6 g of α-methylstyrene, was added and the mixture was stirred for 5 minutes, followed by the addition of 26 g of 10% strength aqueous ammonia; the reaction mixture was stirred at 92° C. for a further 15 minutes. Subsequently 3.6 g of a 2.5% strength solution of sodium persulfate were metered in over the course of 3 minutes. Preemulsion 3, consisting of 158 g of water, 5.9 g of arylsulfonate (15% strength), 20.2 g of methyl methacrylate and 198 g of styrene, was metered in together with 23.7 g of a 2.5% strength solution of sodium persulfate over the course of 90 minutes at 92° C. After a feed time of 45 minutes, 28.6 g of 7% strength itaconic acid were added to preemulsion 3. Finally polymerization was continued for 30 minutes. Residual monomers were reduced by a final chemical deodorization. For this purpose 12.0 g of a 10% strength solution of tert-butyl hydroperoxide and 12.0 g of a 10% strength solution of ascorbic acid were metered in parallel into the reaction mixture over the course of 60 minutes at 92° C.

Solids content: 28.8%
pH: 8.0
Particle size (Autosizer): not measurable

### Whiteness: 72

### Dispersion C5:

The initial charge, consisting of 458 g of water and 154.5 g of dispersion B5, was heated to a temperature of 82° C. under a nitrogen atmosphere in a polymerization vessel equipped with an anchor stirrer, reflux condenser and two feed vessels and, following addition of 12.8 g of a 2.5% strength solution of sodium persulfate, polymerization was commenced for 5 minutes. Then preemulsion 1, consisting of 159 g of water, 6.7 g of arylsulfonate (15% strength), 9.8 g of methacrylic acid and 156 g of styrene, was metered in together with 16.8 g of a 2.5% strength solution of sodium persulfate over the course of 90 minutes at 82° C. After the end of both feeds, the internal temperature was raised to 92° C. over the course of 30 minutes and then preemulsion 2, consisting of 14 g of water, 0.5 g of arylsulfonate (15% strength) and 13.6 g of α-methylstyrene, was added and the mixture was stirred for 5 minutes, followed by the addition of 26 g of 10% strength aqueous ammonia; the reaction mixture was stirred at 92° C. for a further 15 minutes. Subsequently 3.6 g of a 2.5% strength solution of sodium persulfate were metered in over the course of 3 minutes. Preemulsion 3, consisting of 157 g of water, 5.9 g of arylsulfonate (15% strength), 20.2 g of methyl methacrylate and 198 g of styrene, was metered in together with 23.7 g of a 2.5% strength solution of sodium persulfate over the course of 100 minutes at 92° C. Finally polymerization was continued for 30 minutes. Residual monomers were reduced by a final chemical deodorization. For this purpose 12.0 g of a 10% strength solution of tert-butyl hydroperoxide and 12.0 g of a 10% strength solution of ascorbic acid were metered in parallel into the reaction mixture over the course of 60 minutes at 92° C.

Solids content: 28.9%
pH: 8.3
Particle size (Autosizer): 571 nm (0.06 PD)

### Whiteness: 78

### Dispersion C6:

The initial charge, consisting of 458 g of water and 154.5 g of dispersion B6, was heated to a temperature of 82° C. under a nitrogen atmosphere in a polymerization vessel equipped with an anchor stirrer, reflux condenser and two feed vessels and, following addition of 12.8 g of a 2.5% strength solution of sodium persulfate, polymerization was commenced for 5 minutes. Then preemulsion 1, consisting of 159 g of water, 6.7 g of arylsulfonate (15% strength), 9.8 g of methacrylic acid and 156 g of styrene, was metered in together with 16.8 g of a 2.5% strength solution of sodium persulfate over the course of 90 minutes at 82° C. After the end of both feeds, the internal temperature was raised to 92° C. over the course of 30 minutes and then preemulsion 2, consisting of 14 g of water, 0.5 g of arylsulfonate (15% strength) and 13.6 g of α-methylstyrene, was added and the mixture was stirred for 5 minutes, followed by the addition of 26 g of 10% strength aqueous ammonia; the reaction mixture was stirred at 92° C. for a further 15 minutes. Subsequently 3.6 g of a 2.5% strength solution of sodium persulfate were metered in over the course of 3 minutes. Preemulsion 3, consisting of 157 g of water, 5.9 g of arylsulfonate (15% strength), 20.2 g of methyl methacrylate and 198 g of styrene, was metered in together with 23.7 g of a 2.5% strength solution of sodium persulfate over the course of 100 minutes at 92° C. Finally polymerization was continued for 30 minutes. Residual monomers were reduced by a final chemical deodorization. For this purpose 12.0 g of a 10% strength solution of tert-butyl hydroperoxide and 12.0 g of a 10% strength solution of ascorbic acid were metered in parallel into the reaction mixture over the course of 60 minutes at 92° C.

Solids content: 29.4%
pH: 8.8
Particle size (Autosizer): 560 nm (0.11 PD)

### Whiteness: 77

### Dispersion C7:

The initial charge, consisting of 458 g of water and 155.3 g of dispersion B7, was heated to a temperature of 82° C. under a nitrogen atmosphere in a polymerization vessel equipped with an anchor stirrer, reflux condenser and two feed vessels and, following addition of 12.8 g of a 2.5% strength solution of sodium persulfate, polymerization was commenced for 5 minutes. Then preemulsion 1, consisting of 159 g of water, 6.7 g of arylsulfonate (15% strength), 9.8 g of methacrylic acid and 156 g of styrene, was metered in together with 16.8 g of a 2.5% strength solution of sodium persulfate over the course of 90 minutes at 82° C. After the end of both feeds, the internal temperature was raised to 92° C. over the course of 30 minutes and then preemulsion 2, consisting of 14 g of water, 0.5 g of arylsulfonate (15% strength) and 13.6 g of α-methylstyrene, was added and the mixture was stirred for 5 minutes, followed by the addition of 26 g of 10% strength aqueous ammonia; the reaction mixture was stirred at 92° C. for a further 15 minutes. Subsequently 3.6 g of a 2.5% strength solution of sodium persulfate were metered in over the course of 3 minutes. Preemulsion 3, consisting of 157 g of water, 5.9 g of arylsulfonate (15% strength), 20.2 g of methyl methacrylate and 198 g of styrene, was metered in together with 23.7 g of a 2.5% strength solution of sodium persulfate over the course of 100 minutes at 92° C. Finally polymerization was continued for 30 minutes. Residual monomers were reduced by a final chemical deodorization. For this purpose 12.0 g of a 10% strength solution of tert-butyl hydroperoxide and 12.0 g of a 10% strength solution of ascorbic acid were metered in parallel into the reaction mixture over the course of 60 minutes at 92° C.

Solids content: 29.4%
pH: 8.8
Particle size (Autosizer): 578 nm (0.08 PD)

### Whiteness: 77

### Dispersion C8:

The initial charge, consisting of 458 g of water and 154.5 g of dispersion B8, was heated to a temperature of 82° C. under a nitrogen atmosphere in a polymerization vessel equipped with an anchor stirrer, reflux condenser and two feed vessels and, following addition of 12.8 g of a 2.5% strength solution of sodium persulfate, polymerization was commenced for 5 minutes. Then preemulsion 1, consisting of 159 g of water, 6.7 g of arylsulfonate (15% strength), 9.8 g of methacrylic acid and 156 g of styrene, was metered in together with 16.8 g of a 2.5% strength solution of sodium persulfate over the course of 90 minutes at 82° C. After the end of both feeds, the internal temperature was raised to 92° C. over the course of 30 minutes and then preemulsion 2, consisting of 14 g of water, 0.5 g of arylsulfonate (15% strength) and 13.6 g of a-methylstyrene, was added and the mixture was stirred for 5 minutes, followed by the addition of 26 g of 10% strength aqueous ammonia; the reaction mixture was stirred at 92° C. for a further 15 minutes. Subsequently 3.6 g of a 2.5% strength solution of sodium persulfate were metered in over the course of 3 minutes. Preemulsion 3, consisting of 157 g of water, 5.9 g of arylsulfonate (15% strength), 20.2 g of methyl methacrylate and 198 g of styrene, was metered in together with 23.7 g of a 2.5% strength solution of sodium persulfate over the course of 100 minutes at 92° C. Finally polymerization was continued for 30 minutes. Residual monomers were reduced by a final chemical deodorization. For this purpose 12.0 g of a 10% strength solution of tert-butyl hydroperoxide and 12.0 g of a 10% strength solution of ascorbic acid were metered in parallel into the reaction mixture over the course of 60 minutes at 92° C.

Solids content: 29.3%
pH: 8.6
Particle size (Autosizer): 544 nm (0.13 PD)

### Whiteness: 76

### Preparation of the Aqueous Dispersion of the Film-forming Polymer (PD):

Feeds 1A and 2 were brought together in a section of pipeline. Feed 1B was then metered into this mixture of feeds 1A and 2. The mixture of feeds 1A, 1B, and 2 was then emulsified by means of an inline mixing element (a or b), which was mounted immediately prior to the stirred tank in the feed line, and then entered the stirred tank.

Inline mixing elements used were as follows:

a) a static mixer of type SMX-S, DN 3.2, consisting of 10 mixing elements, from Sulzer

Chemtech;

b) a toothed wheel dispersing machine, Megatron MT 5000, from Kinematica.

### Dispersion 1:

A stirred tank was charged with 13 kg of water, which was heated to 90° C. Then 5% of feed 1 and 9% of feed 2 were added, and polymerization was commenced for 5 minutes. Thereafter the remainders of feeds 1A and B, and also feed 2, were metered in over the course of 3 h, in each case by one of the above-described metering methods, with the polymerization temperature being maintained. This was followed by continued polymerization for 1 hour in order to complete the conversion.

| Feed 1: | | |
|---|---|---|
| A: | 24.94 kg | water |
| | 4.33 kg | emulsifier I |
| | 1.25 kg | acrylic acid |
| | 1.50 kg | 50% strength by weight aqueous |
| | | solution of acrylamide |
| B: | 25.00 kg | n-butyl acrylate |
| | 23.00 kg | vinyl acetate |
| Feed 2: | | |
| | Solution of: | |
| | 0.375 kg | sodium peroxodisulfate |
| | 4.98 kg | water |

Solids content: 52.0%

### Dispersion 2:

A stirred tank was charged with 15 kg of water, which was heated to 85° C. Then 6% of feed 1 and 10% of feed 2 were added, and polymerization was commenced for 10 minutes. Thereafter the remainders of feeds 1A and B, and also feed 2, were metered in over the course of 3.5 h, in each case by one of the above-described metering methods, with the polymerization temperature being maintained. This was followed by continued polymerization for 1 hour in order to complete the conversion.

| Feed 1: | | |
|---|---|---|
| A: | 19.01 kg | water |
| | 2.00 kg | emulsifier II |
| B: | 30.00 kg | n-butyl acrylate |
| | 20.00 kg | styrene |
| Feed 2: | | |
| | Solution of: | |
| | 0.30 kg | sodium peroxodisulfate |
| | 4.70 kg | water |

Solids content: 55.6%

### Dispersion 3:

A stirred tank was charged with 4.33 kg of water, which was heated to 85° C. Then 5% of feed 1 and 8% of feed 2 were added, and polymerization was commenced for 5 minutes. Thereafter the remainders of feeds 1A and B, and also feed 2, were metered in over the course of 3.5 h, in each case by one of the above-described metering methods, with the polymerization temperature being maintained. This was followed by continued polymerization for 1 hour in order to complete the conversion.

| Feed 1: | | |
|---|---|---|
| A: | 10.25 kg | water |
| | 1.33 kg | emulsifier II |
| | 1.50 kg | emulsifier III |
| | 1.00 kg | acrylic acid |
| | 1.40 kg | 25% strength by weight aqueous |
| | | solution of sodium hydroxide |
| B: | 15.00 kg | ethylhexyl acrylate |
| | 34.00 kg | n-butyl acrylate |
| Feed 2: | | |
| | Solution of: | |
| | 0.35 kg | sodium peroxodisulfate |
| | 5.48 kg | water |

Solids content: 68.6%

### Dispersion 4:

A pressure-rated stirred tank was charged with a mixture of 16.7 kg of water and 0.3 kg of itaconic acid and this initial charge was heated to 85° C. Then 4.8% of feed 1 and 9% of feed 2 were added, and polymerization was commenced for 10 minutes. Thereafter the remainders of feeds 1A and B, and also feed 2, were metered in over the course of 4.5 h, in each case by one of the above-described metering methods, with the polymerization temperature being maintained. This was followed by continued polymerization for 1.5 hours in order to complete the conversion.

| Feed 1: | | |
|---|---|---|
| A: | 19.21 kg | water |
| | 3.00 kg | emulsifier II |
| | 0.69 kg | acrylic acid |
| | 0.40 kg | 25% strength by weight aqueous |
| | | solution of sodium hydroxide |
| B: | 31.00 kg | styrene |
| | 18.00 kg | butadiene |
| | 0.44 kg | tert-dodecyl mercaptan |
| Feed 2: | | |
| | Solution of: | |
| | 0.35 kg | sodium peroxodisulfate |
| | 5.50 kg | water |

Solids content: 53.7%

Emulsifiers used here were as follows:
Emulsifier I: 30% strength by weight aqueous solution of the sulfuric monoester of ethoxylated isononylphenol, EO degree: 25
Emulsifier II: 15% strength by weight aqueous solution of sodium lauryl sulfate
Emulsifier III: 20% strength by weight aqueous solution of ethoxylated isooctylphenol, EO degree: 25

Example formulations and tests

Paint formulations for interior paints were produced, composed of

| Formulation | Example 1 | Example 2 | Example 3 | Example 4 |
|---|---|---|---|---|
| Water | 326 | 326 | 326 | 326 |
| Natrosol 250 HR (Hercules-Aqualon) | 6 | 6 | 6 | 6 |
| TKPP, 50% form (Ronas Chemicals) | 2 | 2 | 2 | 2 |
| Pigmentverteiler S (BASF SE) | 4 | 4 | 4 | 4 |
| Parmetol A 26 (Schülke & Mayr) | 3 | 3 | 3 | 3 |
| Agitan 280 (Münzing) | 2 | 2 | 2 | 2 |
| White spirit (180-210° C.) | 12 | 12 | 12 | 12 |
| (DHC Solvent Chemie) | | | | |
| Texanol (Eastman) | 13 | 13 | 13 | 13 |
| Tronox CR-828 (Tronox) | 115 | 115 | 109 | 104 |
| Omyacarb 2 GU (Omya) | 205 | 205 | 210 | 215 |
| Plustalc C 700 AW (Mondominerals) | 60 | 60 | 60 | 60 |
| Omyacarb 5 GU (Omya) | 160 | 160 | 160 | 160 |
| Agitan 280 (Münzing) | 2 | 2 | 2 | 2 |
| Dispersion 3 | 90 | | | |
| Dispersion 3/Dispersion C7 (9:1) | | 90 | 90 | 90 |
| Water | 0 | 0 | 1 | 1 |
| Total | 1000 | 1000 | 1000 | 1000 |
| Solids content (%) | 59.4 | 59.2 | 59.1 | 59.1 |
| Volume solids content (%) | 38.2 | 38.1 | 38.2 | 38.2 |
| PVC (%) | 81.6% | 81.6% | 81.7% | 81.7% |
| Density of formulation (calculated) | 1.553 | 1.552 | 1.549 | 1.547 |
| ICI | 2.5 | 2.5 | 2.5 | 2.4 |
| KU after 24 h | 132 | 128 | 127 | 129 |
| KU after 14 d 50° C. | 126 | 124 | 120 | 125 |
| Density | 1.556 | 1.553 | 1.549 | 1.548 |
| Contrast ratio (CR, %) | 97.24 | 97.25 | 97.14 | 97.67 |
| | 98.19 | 98.42 | 98.46 | 98.42 |
| | 98.91 | 99.22 | 98.98 | 99.09 |
| Lightness (%) | 90.96 | 91.37 | 91.12 | 91.07 |
| | 91.67 | 91.76 | 91.83 | 91.69 |
| | 92.02 | 92.26 | 92.23 | 92.22 |
| Hiding power at 98% CR | 7.9 | 8.1 | 8.0 | 8.8 |
| Scrub resistance after 7 days and a | 22 | 25 | 25 | 28 |
| further 2 days with 50° C. drying | | | | |
| ISO 13300 | | | | |
| Gloss after 24 h, 240 μm film drawn | | | | |
| down | | | | |
| 60° | 2.1 | 2.1 | 2.1 | 2.1 |
| 85° | 3.9 | 4.1 | 4.2 | 4.1 |

The aqueous polymer dispersion selected was dispersion 3. In example 2, nine parts by weight of dispersion 3 were replaced by nine parts by weight of dispersion C7. The volume solids was not compensated. In example 3, nine parts by weight of dispersion 3 were replaced by nine parts by weight of dispersion C7. Tronox CR-828 was reduced by six parts by weight. Omyacarb 2 GU was increased by five parts by weight. Example 3 has the same volume solids content as example 1. In example 4, nine parts by weight of dispersion 3 were replaced by nine parts by weight of dispersion C7. Tronox CR-828 was reduced by eleven parts by weight. Omyacarb 2 GU was increased by ten parts by weight. Example 4 has the same volume solids content as example 1. In example 3 it was possible, in comparison to example 1, to increase the hiding power at a contrast ratio of 98% by 0.1, and the wet abrasion resistance by 3 μm. In example 4, it was possible, in comparison to example 1, to increase the hiding power at a contrast ratio of 98% by 0.9, and the wet abrasion resistance by 6 μm.

1. A method for producing a coating composition, the method comprising blending an aqueous dispersion (AD1) comprising hollow organic particles with an aqueous dispersion (AD2) comprising a film-forming polymer (PD),
wherein the hollow organic particles are obtained by a multistage emulsion polymerization process, comprising:
i) reacting a seed with a swell seed comprising 0 to 100% by weight of a nonionically ethylenically unsaturated monomer and 0 to 40% by weight of a monoethylenically unsaturated hydrophilic monomer, based in each case on a total weight of a core stage polymer comprising the seed and the swell seed;,
(ii) polymerizing a first shell comprising 85% to 99.9% by weight of a nonionically ethylenically unsaturated monomer and 0.1% to 15% by weight of a hydrophilic monoethylenically unsaturated monomer on the core stage polymer;
(iii) polymerizing a second shell comprising 85% to 99.9% by weight of a nonionically ethylenically unsaturated monomer and 0.1% to 15% by weight of a hydrophilic monoethylenically unsaturated monomer on the first shell;
(iv) adding at least one plasticizer monomer having a ceiling temperature of less than 181° C;
(v) neutralizing any resulting particles with a base to a pH of at least 7.5 or more;
(vi) polymerizing a third shell comprising 90% to 99.9% by weight of a nonionically ethylenically unsaturated monomer and 0.1% to 10% by weight of a hydrophilic monoethylenically unsaturated monomer; and
(vii) optionally, polymerizing a further shell comprising a nonionically ethylenically unsaturated monomer and a hydrophilic monoethylenically unsaturated monomer.

2. The method of claim 1, wherein a weight ratio of the swell seed to the seed is in a range from 2:1 to 50:1.

3. The method of claim 1, wherein an average particle size, in an unswollen state, of the core stage polymer is 100 to 400 nm.

4. The method of claim 1, wherein a weight ratio of the core stage polymer to the first shell (ii) is in a range from 20:1 to 1:1.

5. The method of claim 1, wherein a weight ratio of the first shell (ii) to the second shell (iii) is 1:30 to 1:1.

6. The method of claim 1, wherein the plasticizer monomer (iv) is at least one selected from the group consisting of α-methylstyrene, esters an of 2-phenylacrylic acid/atropic acid, 2 methyl-2-butene, 2,3-dimethyl-2-butene, 1.1-diphenylethene, and methyl 2-tert-butylacrylate.

7. A method of increasing at least one selected from the group consisting of a hiding power and a wet abrasion resistance of an aqueous coating material, the method comprising:
combining the coating composition of claim 1 with at least one additive and water.

8. The method of claims 7, wherein the coating composition is a paint.

9. The method of claim 8, wherein the paint is an interior paint or an exterior paint.

10. The method of claim 1, wherein the film-forming polymer (PD) comprises, in reacted form, a monomer combination selected from the group consisting of n-butyl acrylate with vinyl acetate, n-butyl acrylate with styrene, n-butyl acrylate with ethylhexyl acrylate, butadiene with styrene, butadiene with acrylonitrile, butadiene with methacrylonitrile, butadiene with acrylonitrile and methacrylonitrilea, butadiene and isoprene with acrylonitrile, butadiene and isoprene with methacrylonitrile, and butadiene and isoprene with acrylonitrile and methacrylonitrile, butadiene with an acrylic ester, and butadiene with a methacrylic ester.

11. The method of claim 10, wherein the monomer combination further comprises at least one monomer selected from the group consisting of acrylic acid, methacrylic acid, acrylamide, and methacrylamide.

12. The method of claim 1, wherein a blend ratio of the aqueous dispersion (AD1) to the aqueous dispersion (AD2) is 30:70.

13. The method of claim 1, wherein a blend ratio of the aqueous dispersion (AD1) to the aqueous dispersion (AD2) is 20:80.

14. The method of claim 1, wherein a blend ratio of the aqueous dispersion (AD1) to the aqueous dispersion (AD2) is 5:95.

15. The method of claim 1, wherein a blend ratio of the aqueous dispersion (AD1) to the aqueous dispersion (AD1) is 10:90.

16. A coating material composition, comprising:
a coating composition obtained by the process of claim 1;
optionally, at least one additive selected from the group consisting of an inorganic filler and an inorganic pigment;
an auxiliary; and
water to 100% by weight.

17. The coating material of claim 16, comprising:
3% to 60% by weight, based on a solids content, of the coating composition;
10% to 70% by weight of the additive; and
0.1% to 20% by weight of the auxiliary.

18. The composition of claim 17, comprising:
10% to 60% by weight, based on a solids content, of the coating composition; and
0.1% to 20% by weight of the auxiliary.

19. The method of claim 1, wherein the plasticizer has a ceiling temperature of less than 95° C.

20. The method of claim 1, wherein the multistage emulsion polymerization process further comprises, prior to the reacting (i):
polymerizing the seed.
